(19) United States
(12) Patent Application Publication
(10) Pub. No.: US 2017/0277096 A1
(43) Pub. Date: Sep. 28, 2017

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Naoya MITAMURA, Ebina-shi (JP); Yoshiyuki TAKASHIMA, Ebina-shi (JP); Koji DEGUCHI, Ebina-shi (JP)

(73) Assignee: FUJI XEROX CO., LTD., Tokyo (JP)

(21) Appl. No.: 15/261,029

(22) Filed: Sep. 9, 2016

(30) Foreign Application Priority Data
Mar. 23, 2016 (JP) 2016-059018

(51) Int. Cl. G03G 15/00

(52) U.S. Cl. CPC G03G 15/5062

(57) ABSTRACT

An image forming apparatus includes: a first rotating body pair that transports a recording medium; a second rotating body pair that transports the recording medium transported by the first rotating body pair; a first detection unit that detects the recording medium at a first position in a transporting width direction of the recording medium; a second detection unit that detects the recording medium at a second position, the second position being different from the first position in the transporting width direction; and a modification unit that modifies a shape of an image to be formed on the recording medium in accordance with a difference between a detection time during which the recording medium is detected at the first position and a detection time during which the recording medium is detected at the second position.

### CROSS-REFERENCE TO RELATED APPLICATIONS

This application is based on and claims priority under 35 USC 119 from Japanese Patent Application No. 2016-059018 filed on Mar. 23, 2016.

### BACKGROUND

### Technical Field

The present invention relates to an image forming apparatus, and a non-transitory computer readable medium,

### SUMMARY

According to an aspect of the invention, there is provided an image forming apparatus including: a first rotating body pair that transports a recording medium; a second rotating body pair that transports the recording medium transported by the first rotating body pair; a first detection unit that detects the recording medium at a first position in a transporting width direction of the recording medium, the transporting width direction being a direction that is perpendicular to a transporting direction of the recording medium; a second detection unit that detects the recording medium at a second position, the second position being different from the first position in the transporting width direction; and a modification unit that modifies a shape of an image to be formed on the recording medium in accordance with a difference between a detection time during which the recording medium is detected at the first position and a detection time during which the recording medium is detected at the second position.

### BRIEF DESCRIPTION OF THE DRAWINGS

Exemplary embodiments of the present invention will be described in detail based on the following figures, wherein:

FIG. 1 is a schematic side view illustrating an overall configuration of an image forming apparatus according to an exemplary embodiment;

FIG. 2 is a front view illustrating an installation state of a paper sensor of the image forming apparatus according to the exemplary embodiment;

FIG. 3 is a front view illustrating an example of a state of paper which is transported in the image forming apparatus according to the exemplary embodiment;

FIG. 4 is a front view illustrating another example of the state of paper which is transported in the image forming apparatus according to the exemplary embodiment;

FIG. 5 is a table illustrating a relationship between a detection time difference, a transporting period of printing paper, a transporting speed of the printing paper, a length of a formed image, and parallelism, in the image forming apparatus according to the exemplary embodiment, the detection time difference obtained by subtracting a detection time of a paper sensor on an in-side from a detection time of a paper sensor on an out-side;

FIG. 6 is a block diagram illustrating an electrical configuration of the image forming apparatus according to the exemplary embodiment;

FIG. 7 is a flowchart illustrating a flow of processing performed by a program for adjustment processing according to a first exemplary embodiment;

FIG. 8 is a front view illustrating an example of a positional relationship between a transfer roll and a fixing roll pair in the image forming apparatus according to the exemplary embodiment;

FIG. 9 is a front view illustrating another example of the positional relationship between the transfer roll and the fixing roll pair in the image forming apparatus according to the exemplary embodiment;

FIG. 10 is a graph illustrating an example of parallelism of a formed image in a case where a distance between the in-side and the out-side of the image forming apparatus according to the exemplary embodiment is changed;

FIG. 11 is a front view illustrating an example of a positional relationship between the transfer roll and a registration roll pair in the image forming apparatus according to the exemplary embodiment;

FIG. 12 is a front view illustrating an example of a positional relationship between the transfer roll, the fixing roll pair, and the registration roll pair, in the image forming apparatus according to the exemplary embodiment;

FIG. 13 is a flowchart illustrating a flow of processing performed by a program for adjustment processing according to a second exemplary embodiment; and

FIG. 14 is a flowchart illustrating a flow of processing performed by a program for adjustment processing according to a third exemplary embodiment.

### DETAILED DESCRIPTION

Hereinafter, an image forming apparatus according to exemplary embodiments will be described in detail with reference to the accompanying drawings. A case where a direct transfer type monochromic image forming apparatus is employed as an image forming apparatus according to each of the exemplary embodiments will be described.

### First Exemplary Embodiment

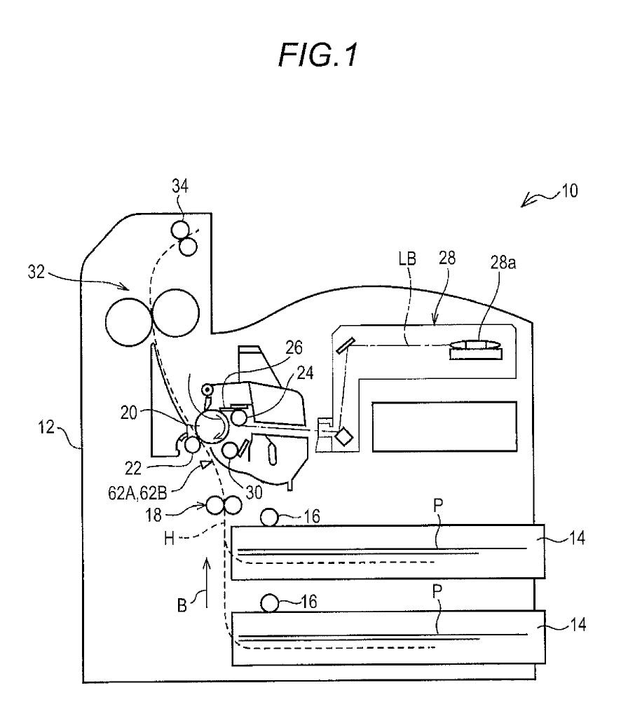

As illustrated in FIG. 1, an image forming apparatus 10 according to the first exemplary embodiment includes a housing 12 which accommodates components of the image forming apparatus 10. A paper feeding unit 14 is provided on a lower side of the inside of the housing 12. In the paper feeding unit 14, pieces of paper P which is a recording medium are stacked and accommodated so as to have a shape of a bundle. In the exemplary embodiment, a case where paper P is used as a recording medium will be described. However, the recording medium is not limited to the paper P, and the recording medium may be a film and the like. A pickup roll 16 is disposed right over an entrance and outlet port of paper P in the paper feeding unit 14, The pickup roll 16 is in pressure contact with an end portion of an upper surface of paper P, and carries the paper P from the paper feeding unit 14.

A registration roll pair 18 is provided over the pickup roll 16. The registration roll pair 18 is used for performing skew correction on paper P. A photoconductor drum 20 and a transfer roll 22 are provided over the registration roll pair 18. The registration roll pair 18 is an example of a first rotating body pair and a second rotating body pair.

A cleaning device 26, a charging roll 24, an exposure device 28, and a developing roll 30 are provided on the outer circumference of the photoconductor drum 20, in this order.

The cleaning device 26, the charging roll 24, the exposure device 28, and the developing roll 30 are provided along an A direction which is a rotation direction of the photoconductor drum 20.

The cleaning device 26 removes a toner remaining on the photoconductor drum 20. The charging roll 24 charges a surface of the photoconductor drum 20. The exposure device 28 includes a laser generation unit 28a which generates a laser beam. The laser generation unit 28a irradiates the photoconductor drum 20 which has uniformly charged by the charging roll 24, with laser LB, so as to form an electrostatic latent image on the photoconductor drum 20. The developing roll 30 develops the electrostatic latent image which has been formed on the photoconductor drum 20, by using a toner, so as to form a toner image on the photoconductor drum 20.

The transfer roll 22 nips paper P between the transfer roll 22 and the photoconductor drum 20, and transfers the toner image which has formed on the photoconductor drum 20, to the paper P. The photoconductor drum 20 and the transfer roll 22 are an example of the second rotating body pair.

A fixing roll pair 32 is provided over the photoconductor drum 20 and the transfer roll 22. The fixing roll pair 32 is used for fixing the toner image which has been transferred, onto the paper P. The fixing roll pair 32 includes a heat source. The fixing roll pair 32 presses and heats the paper P to which the toner image has been transferred, and thus fixes the toner image to the paper P. The fixing roll pair 32 is an example of the first rotating body pair.

A carrying-out roll pair 34 for carrying the paper P outwardly is provided over the fixing roll pair 32.

Next, the entire flow of forming an image on paper P in the image forming apparatus 10 will be described.

Firstly, paper P is carried out from the paper feeding unit 14. The carried-out paper P is transported to the registration roll pair 18 by plural transport roll pairs. The paper P is subjected to skew correction in a state of being nipped on the registration roll pair 18. The paper P is transported upwardly in a state of being nipped on the registration roll pair 18. Transporting the paper is temporarily stopped by the registration roll pair 18, and then the paper is transported to a transfer position by the transfer roll 22 at a predetermined timing. The transfer position is positioned between the photoconductor drum 20 and the transfer roll 22. A toner image formed on the photoconductor drum 20 is transferred to the paper P which has been transported to the transfer position, by the transfer roll 22. Thus, a toner image is formed. The paper P on which the toner image has been formed is transported to the fixing roll pair 32. The toner image which has been transferred is fixed by the fixing roll pair 32, in a state where the paper P is nipped on the fixing roll pair 32. The paper which has the fixed toner image is transported to the carrying-out roll pair 34. Then, the paper P is output to the outside of the housing 12 by the carrying-out roll pair 34.

Next, a transporting path H of paper P will be described.

A transporting path H which is gently curved upwardly is formed between the entrance and outlet port of the paper feeding unit 14 and the registration roll pair 18. The transporting path H is extended upwardly with passing through the photoconductor drum 20, the transfer roll 22, the fixing roll pair 32, and the carrying-out roll pair 34 in this order, and the transporting path H is linked to the outside of the housing 12. While paper P accommodated in the paper feeding unit 14 which is disposed on the lower side of the housing 12 is transported toward an upper part of a vertical direction along the transporting path H, a toner image is formed by the photoconductor drum 20 and the transfer roll 22. After the toner image is fixed by the fixing roll pair 32, the paper P is output to the outside of the housing 12,

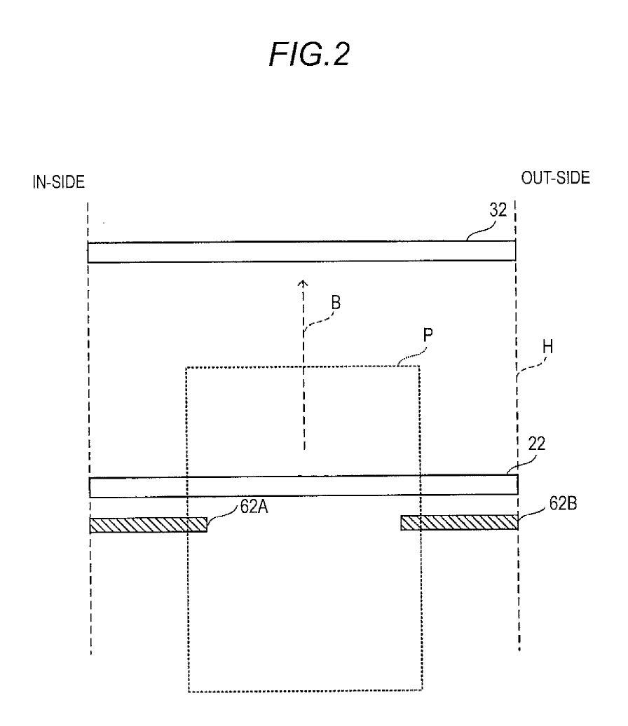

As illustrated in FIGS. 1 and 2, the image forming apparatus 10 according to the exemplary embodiment includes paper sensors 62A and 62B between the registration roll pair 18 and the transfer roll 22 on the transporting path H. The paper sensors 62A and 62B detect paper P. As illustrated in FIG. 2, in the exemplary embodiment, the paper sensor 62A is provided on one end side (for example, on the left side in the front view (below referred to as “an in-side”)) of a transporting width direction of the transporting path H. The paper sensor 62A detects an area of the in-side of the paper P. The paper sensor 62B is provided on another end side (for example, on the right side in the front view (below referred to as “an out-side”)) of the transporting width direction of the transporting path H.

The paper sensor 62B detects an area of the out-side of the paper P. The paper sensor 62A is an example of a first detection unit, and the paper sensor 62B is an example of a second detection unit.

A detection time during which paper P is continuously detected by the paper sensor 62A corresponds to a transporting period of the in-side of the paper P. A detection time during which the paper P is continuously detected by the paper sensor 62B corresponds to a transporting period of the out-side of the paper P. In the exemplary embodiment, parallelism of an image formed on the paper P is corrected based on a difference between the detection time during which the paper P is continuously detected by the paper sensor 62A, and the detection time during which the paper P is continuously detected by the paper sensor 62B.

The length of the transporting path H from the registration roll pair 18 to the transfer roll 22 is configured so as to be less than the length of paper P in a transporting direction B. Thus, the paper P is in a state of being nipped on the transporting path H by both of the photoconductor drum 20 and the transfer roll 22.

The length of the transporting path H from the transfer roll 22 to the fixing roll pair 32 is configured so as to be less than the length of paper P in the transporting direction B. Thus, the paper P is in a state of being nipped on the transporting path H by both of the fixing roll pair 32 and the transfer roll 22.

Here, when the image forming apparatus 10 forms an image on paper P, the paper P is transported along the transporting path 11, and is detected by the paper sensors 62A and 62B during a period from when the paper P passes through the registration roll pair 18 until the paper P reaches the transfer roll 22.

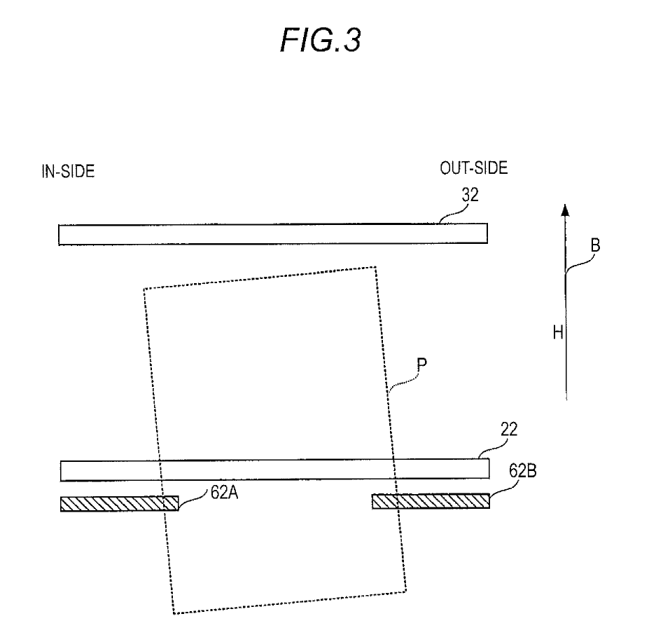

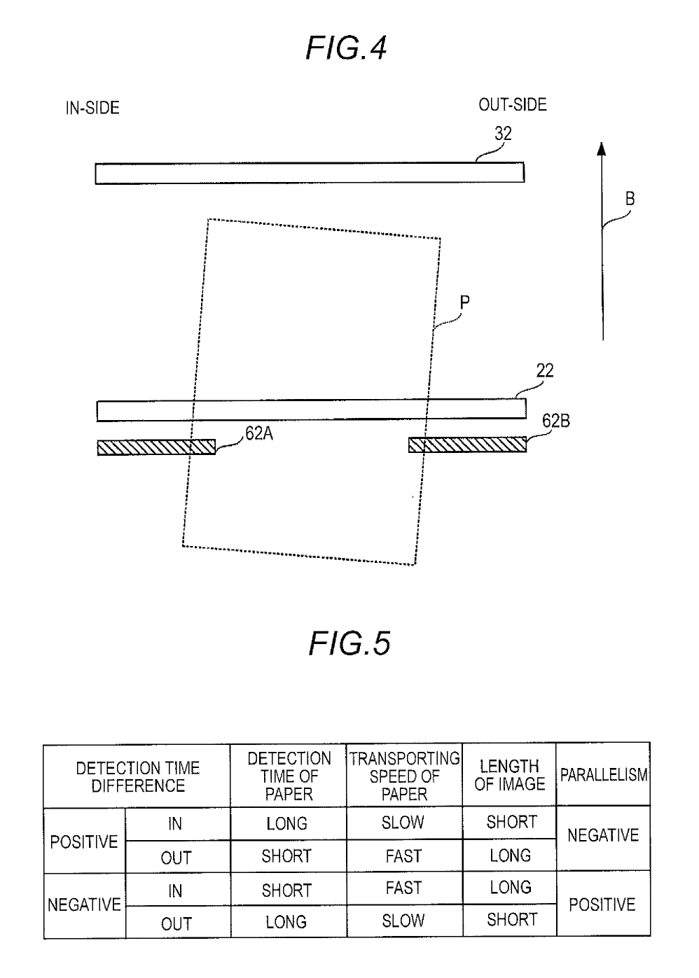

At this time, as illustrated in FIGS. 3 and 4 as an example, the paper may be inclined with respect to the transporting direction B due to a difference of a transporting speed of the paper P in the transporting width direction thereof. As illustrated in FIG. 3, in a case where the transporting speed of the out-side is faster than the transporting speed of the in-side, an end portion of the out-side of the paper P is detected prior to an end portion of the in-side, and a detection time of the end portion on the out-side of the paper P is shorter than a detection time of the end portion on the in-side thereof. As illustrated in FIG. 4, in a case where the transporting speed of the in-side is faster than the transporting speed of the out-side, the end portion of the in-side of the paper P is detected prior to the end portion of the out-side thereof, and a detection time of the end portion on the in-side of the paper P is shorter than a detection time of the end portion on the out-side.

Here, FIG. 5 illustrates a table which shows a relationship between a detection time difference, the transporting period of paper P, the transporting speed of the paper P, the length of an image to be formed, and parallelism. The detection time difference is obtained by subtracting a detection time by the paper sensor 62B (out-side) from a detection time by the paper sensor 62A (in-side).

As illustrated in FIG. 5, in a case where the detection time difference is positive, the detection time of the paper P on the in-side is long and the detection time of the paper on the out-side is short. That is, in a case where the detection time difference is positive, the transporting speed of the paper P on the in-side becomes slow, and the transporting speed of the paper P on the out-side becomes fast. Thus, in a case where the detection time difference is positive, the length of the formed image on the in-side becomes short, and the length of the formed image on the out-side becomes long. Accordingly, parallelism is negative.

In a case where the detection time difference is negative, the detection time of the paper P on the in-side is short and the detection time of the paper on the out-side is long. That is, in a case where the detection time difference is negative, the transporting speed of the paper P on the in-side becomes fast, and the transporting speed of the paper P on the out-side becomes slow. Thus, in a case where the detection time difference is negative, the length of the formed image on the in-side becomes long, and the length of the formed image on the out-side becomes short. Accordingly, parallelism is positive.

Next, an electrical configuration of the image forming apparatus 10 according to the exemplary embodiment will be described.

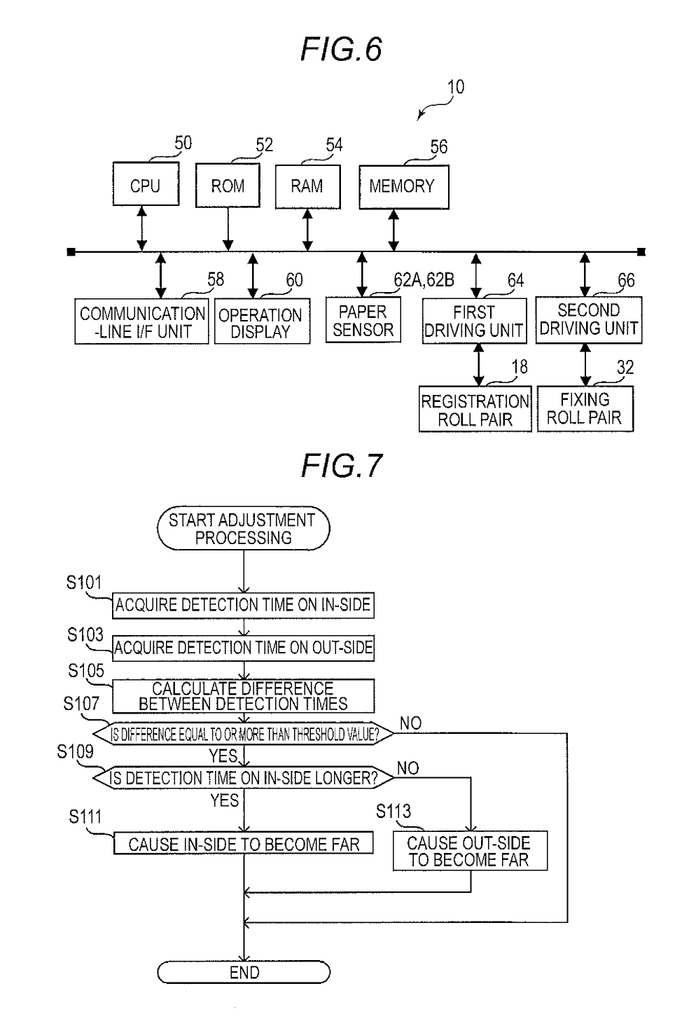

As illustrated in FIG. 6, the image forming apparatus 10 according to the exemplary embodiment includes a central processing unit (CPU) 50, and a read only memory (ROM) 52. The CPU 50 performs various types of processing which includes adjustment processing (will be described later). The ROM 52 stores a program and various types of information which are used for processing of the CPU 50. The image forming apparatus 10 includes a random access memory (RAM) 54, and a memory 56 such as a nonvolatile memory. The RAM 54 temporarily stores various types of data, as a work area of the CPU 50. The memory 56 stores various types of information which are used for processing of the CPU 50. The image forming apparatus 10 includes a communication line I/F unit 58 which inputs and outputs data from and to an external device. The CPU 50 is connected to the communication-line I/F unit 58. The image forming apparatus 10 includes an operation display 60 which displays various types of information, and inputs information based on a user operation. The CPU 50 is connected to the operation display 60.

The CPU 50 is connected to the paper sensors 62A and 62B which have been described above. If the paper sensors 62A and 62B detect paper P, each of the paper sensors 62A and 62B outputs a detection signal which indicates that the paper P is detected, to the CPU 50.

The image forming apparatus 10 includes a first driving unit 64. The first driving unit 64 drives a mechanism which includes a cam and a motor for changing an angle (simply referred to as “an angle” below) of the registration roll pair 18 of paper P with respect to the transfer roll 22 in a transporting surface of the paper P. The CPU 50 is connected to the first driving unit 64. The image forming apparatus 10 includes a second driving unit 66. The second driving unit 66 drives a mechanism which includes a cam and a motor for changing an angle of the fixing roll pair 32 with respect to the transfer roll 22. The CPU 50 is connected to the second driving unit 66. The first driving unit 64 and the second driving unit 66 are controlled by the CPU 50.

Next, a flow of processing when the CPU 50 of the image forming apparatus 10 according to the exemplary embodiment performs adjustment processing will be described with reference to a flowchart illustrated in FIG. 7. In the exemplary embodiment, a program of the adjustment processing is stored in the memory 56 in advance. However, it is not limited thereto. For example, the program of the adjustment processing may be received from an external device through the communication line I/F unit 58, and be stored in the memory 56. The program of the adjustment processing which has been recorded in a recording medium such as a CD-ROM may be read by a CD-ROM drive, and thus the adjustment processing may be performed.

In Step S101, the CPU 50 acquires a detection time of the paper P on the in-side, which has been detected by the paper sensor 62A.

In Step S103, the CPU 50 acquires a detection time of the paper P on the out-side, which has been detected by the paper sensor 62B.

In Step S105, the CPU 50 calculates a difference between the detection times of the in-side and the out-side.

In Step S107, the CPU 50 determines whether or not the difference of the detection time is equal to or more than a predetermined threshold value. Here, the threshold value is set to be an upper limit value of the difference, so that a distortion amount of an image is in an allowable range. The threshold value is set to have a value which is obtained in advance by a test and the like.

In Step S107, in a case where it is determined that the difference of the detection time is equal to or more than the predetermined threshold value (S107, YES), the process proceeds to Step S109. In Step S107, in a case where it is determined that the difference of the detection time is less than the predetermined threshold value (S107, NO), execution of the program of the adjustment processing is ended.

In Step S109, the CPU 50 determines whether or not the detection time on the in-side is long. As described above, in a case where the detection time on the in-side is long, the in-side of an image formed on paper P is shorter than the out-side thereof. In a case where the detection time on the out-side is long, the out-side of an image formed on paper P is shorter than the in-side thereof.

In Step S109, in a case where it is determined that the detection time on the in-side is long (S109, YES), the process proceeds to Step S111. In Step S109, in a case where it is determined that the detection time on the out-side is long (S109, NO), the process proceeds to Step S113.

In Step S111, the CPU 50 changes a positional relationship between the fixing roll pair 32 and the transfer roll 22, so that a distance of the fixing roll pair 32 of the in-side from the transfer roll 22 becomes far. Then, execution of the program of the adjustment processing is ended.

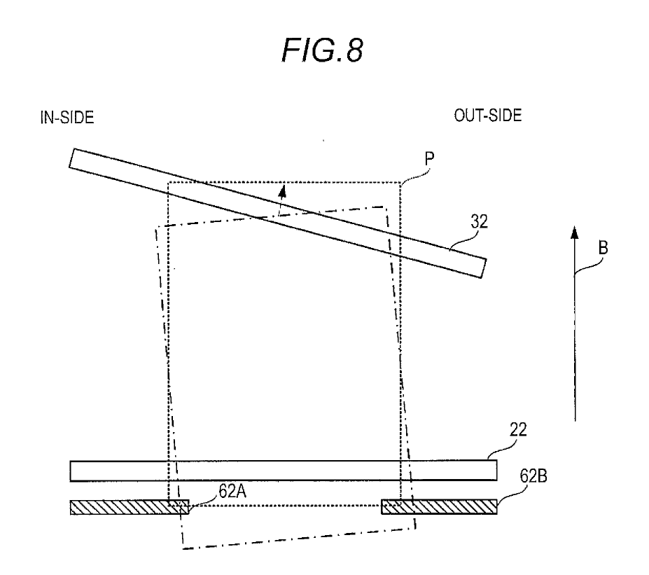

In the exemplary embodiment, as illustrated in FIG. 8, as an example, an angle of the fixing roll pair 32 with respect to the transfer roll 22 is changed, and thus adjustment is performed so that a distance on the in-side between the registration roll pair 18 and the fixing roll pair 32 in the transporting width direction is increased. At this time, the angle of the fixing roll pair 32 with respect to the transfer roll 22 is changed so as to remove the difference between the detection time on the in-side and the detection time on the out-side.

That is, the distance on the in-side between the transfer roIl 22 and the fixing roll pair 32 in the transporting width direction is increased, and thus the in-side of paper P is stretched by the fixing roll pair 32, and is transitioned to the out-side. Thus, the in-side of the formed image becomes long.

In Step S113, the CPU 50 changes the positional relationship between the fixing roll pair 32 and the transfer roll 22, so that the distance of the fixing roll pair 32 on the in-side from the transfer roll 22 becomes far. Then, execution of the program of the adjustment processing is ended.

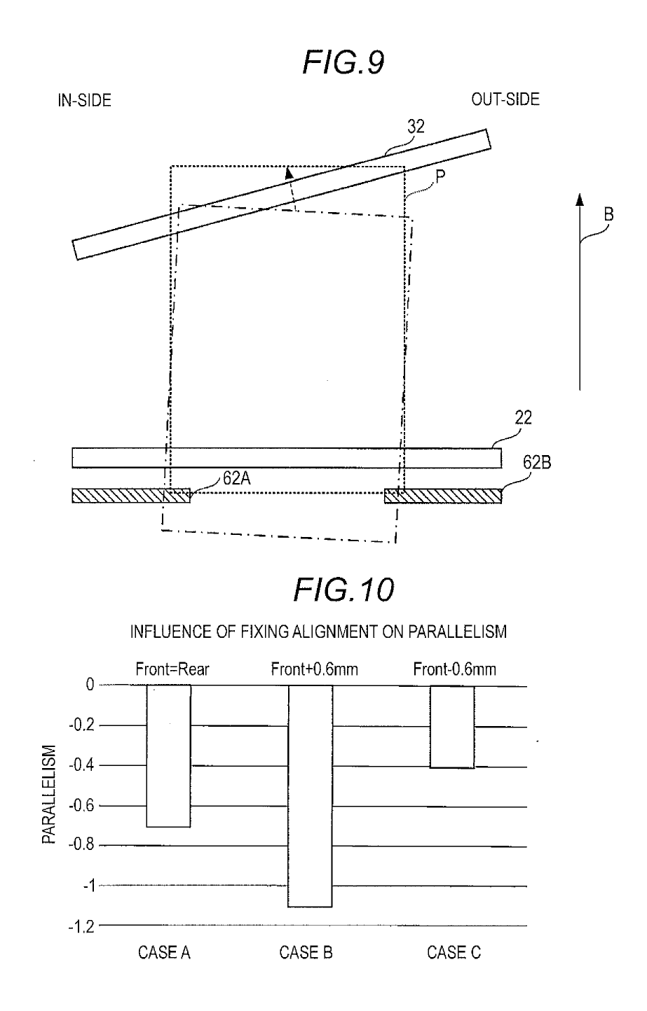

In the exemplary embodiment, as illustrated in FIG. 9, as an example, an angle of the fixing roll pair 32 with respect to the transfer roll 22 is changed, and thus adjustment is performed so that a distance on the in-side between the transfer roll 22 and the fixing roll pair 32 in the transporting width direction is increased. At this time, the angle of the fixing roll pair 32 with respect to the transfer roll 22 is changed so as to remove the difference between the detection time on the in-side and the detection time on the out-side.

That is, the distance on the in-side between the transfer roll 22 and the fixing roll pair 32 in the transporting width direction is increased, and thus the out-side of paper P is stretched to the fixing roll pair 32, and is transitioned to the in-side. Thus, the out-side of the formed image becomes long.

FIG. 10 illustrates an example of parallelism of an image to be formed in a case where at least one of the distance on the in-side between the registration roll pair 18 and the fixing roll pair 32, and the distance on the out-side between the registration roll pair 18 and the fixing roll pair 32 is changed. As illustrated in FIG. 10, the followings are understood. In a case where the distance on the in-side is equal to the distance on the out-side (Case A), parallelism is set to be −0.7. In this case, in a case where an angle of the fixing roll pair 32 with respect to the registration roll pair 18 is changed so that the distance of the inside is longer than the distance on the out-side by 0.6 mm (Case B), the parallelism is −1.1, that is, the parallelism is decreased. In a case where the angle of the fixing roll pair 32 with respect to the registration roll pair 18 is changed so that the distance on the in-side is shorter than the distance on the out-side by 0.6 mm (Case C), the parallelism is 0.4, that is, the parallelism is increased.

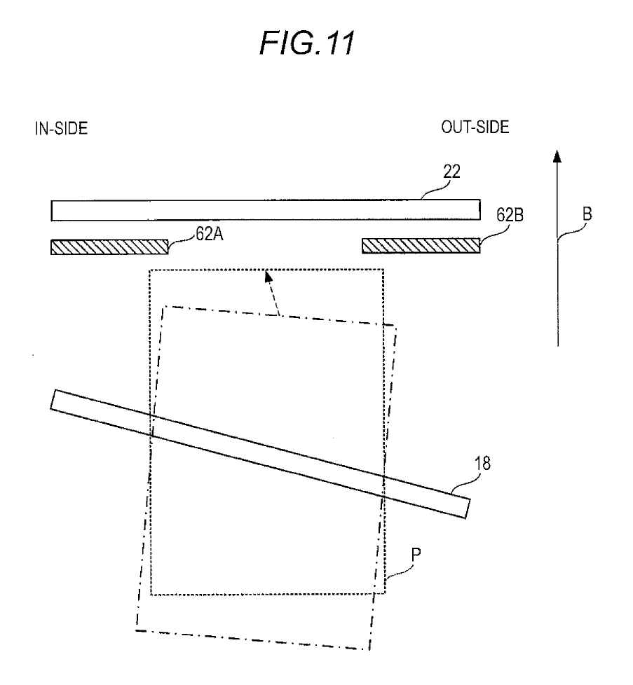

In the exemplary embodiment, a case where the angle of the fixing roll pair 32 with respect to the transfer roll 22 is adjusted is described. However, the target of the adjusting is not limited thereto. As illustrated in FIG. 11 as an example, instead of the angle of the fixing roll pair 32 with respect to the transfer roll 22, an angle of the registration roll pair 18 with respect to the transfer roll 22 may be adjusted. As illustrated in FIG. 11, in a case where the distance of the registration roll pair 18 from the transfer roll 22 on the out-side becomes far, the distance on the out-side between the registration roll pair 18 and the transfer roll 22 in the transporting width direction of the out-side becomes long. Thus, the out-side of paper P is stretched to the transfer roll 22, and is transitioned to the in-side. Accordingly, the out-side of an image to be formed becomes long. In a case where the distance of the registration roll pair IS from the transfer roll 22 on the inside becomes far, the distance on the in-side between the registration roll pair 18 and the transfer roll 22 in the transporting width direction of the in-side becomes long. Thus, the in-side of paper P is stretched to the transfer roll 22, and is transitioned to the out-side. Accordingly, the in-side of an image to be formed becomes long.

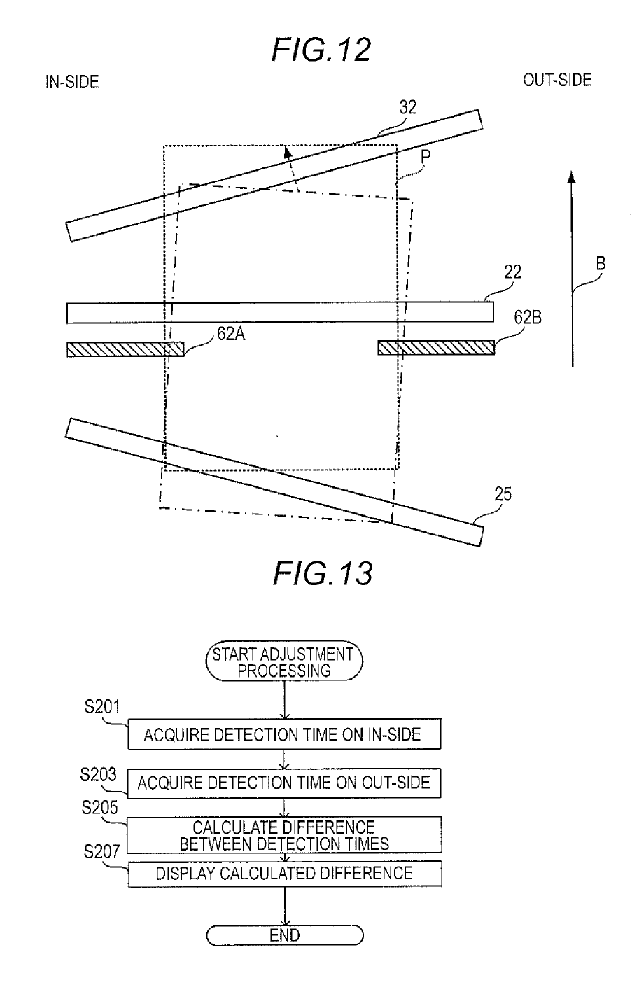

As illustrated in FIG. 12 as an example, both of the angle of the fixing roll pair 32 with respect to the transfer roll 22, and the angle of the registration roll pair 18 with respect to the transfer roll 22 may be changed, and the relative angle between the fixing roll pair 32 and the transfer roll 22 may be adjusted.

### Second Exemplary Embodiment

Next, an image forming apparatus according to a second exemplary embodiment will be described.

In the first exemplary embodiment, a case where the angle of the fixing roll pair 32 with respect to the transfer roll 22 is adjusted in accordance with the detection time difference which is obtained by subtracting the detection time by the paper sensor 62B from the detection time by the paper sensor 62A is described. However, in the second exemplary embodiment, a case where the detection time difference obtained by subtracting the detection time by the paper sensor 62B from the detection time by the paper sensor 62A is suggested, and the angle of the fixing roll pair 32 with respect to the transfer roll 22 is adjusted by a user will be described.

Since other components of the image forming apparatus according to the second exemplary embodiment are the same as those of the image forming apparatus 10 according to the first exemplary embodiment, descriptions of the same components will be omitted.

Next, a flow of processing when the CPU 50 of the image forming apparatus 10 according to the exemplary embodiment performs adjustment processing will be described with reference to a flowchart illustrated in FIG. 13. In the exemplary embodiment, a program of the adjustment processing is stored in the memory 56 in advance. However, it is not limited thereto. For example, the program of the adjustment processing may be received from an external device through the communication line I/F unit 58, and be stored in the memory 56. The program of the adjustment processing which has been recorded in a recording medium such as a CD-ROM may be read by a CD-ROM drive, and thus the adjustment processing maF be performed.

In Step S201, the CPU 50 acquires a detection time of the paper P on the in-side, which has been detected by the paper sensor 62A.

In Step S203, the CPU 50 acquires a detection time of the paper P on the out-side, which has been detected by the paper sensor 62B.

In Step S205, the CPU 50 calculates a difference between the detection times of the in-side and the out-side.

In Step S207, the CPU 50 displays the calculated difference between the detection times of the in-side and the out-side, or an adjustment amount depending on the difference, in the operation display 60.

Then, the CPU 50 ends execution of the program of the adjustment processing. A user confirms the difference between the detection times of the in-side and the out-side, or the adjustment amount depending on the difference and manually adjusts the angle of the fixing roll pair 32 with respect to the transfer roll 22 based on the adjustment amount depending on the difference.

### Third Exemplary Embodiment

Next, an image forming apparatus according to a third exemplary embodiment will be described.

In the first exemplary embodiment, the case where the angle of the fixing roll pair 32 with respect to the transfer roll 22 is adjusted in accordance with the detection time difference which is obtained by subtracting the detection time by the paper sensor 62B from the detection time by the paper sensor 62A is described. However, in the third exemplary embodiment, a case where a correction coefficient for correcting an image to be formed is adjusted in accordance with the detection time difference which is obtained by subtracting the detection time by the paper sensor 62B from the detection time by the paper sensor 62A will be described.

Since other components of the image forming apparatus according to the third exemplary embodiment are the same as those of the image forming apparatus 10 according to the first exemplary embodiment, descriptions of the same components will be omitted.

In the exemplary embodiment, the correction coefficient for correcting an image to be formed has been stored in the memory 56 in advance. When the image forming apparatus 10 forms an image, a shape of an image to be formed is corrected by using the correction coefficient which is stored in the memory 56. The correction coefficient is a correction coefficient for correcting the shape of an image to be formed so that the length of the shape of an image to be formed on one side of which the detection time is long becomes short.

The correction coefficient is used when the correction is performed considering a point that the length of paper P on one side of which the detection time is long among the inside and the out-side of the paper P is short in the image to be formed.

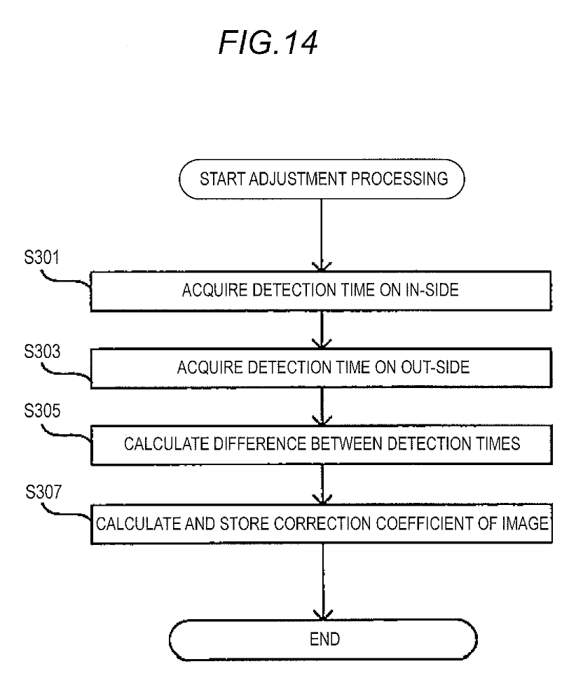

Next, a flow of processing when the CPU 50 of the image forming apparatus 10 according to the exemplary embodiment performs adjustment processing will be described with reference to a flowchart illustrated in FIG. 14. In the exemplary embodiment, a program of the adjustment processing is stored in the memory 56 in advance. However, it is not limited thereto. For example, the program of the adjustment processing may be received from an external device through the communication line I/F unit 58, and be stored in the memory 56. The program of the adjustment processing which has been recorded in a non-transitory recording medium such as a CD-ROM may be read by a CD-ROM drive, and thus the adjustment processing may be performed.

In Step S301, the CPU 50 acquires a detection time of the paper P on the in-side, which has been detected by the paper sensor 62A.

In Step S303, the CPU 50 acquires a detection time of the paper P on the out-side, which has been detected by the paper sensor 62B.

In Step S305, the CPU 50 calculates a difference between the detection times of the in-side and the out-side.

In Step S307, the CPU 50 calculates a correction coefficient for correcting an image to be formed, through image processing.

The CPU 50 stores the calculated correction coefficient in the memory 56, and ends execution of the program of the adjustment processing. Regarding an image formed on paper P, parallelism is corrected based on the correction coefficient which is stored in the memory 56.

In the first exemplary embodiment to the third exemplary embodiment, a case where the paper sensors 62A and 62B are provided between the registration roll pair 18 and the transfer roll 22 is described.

However, it is not limited thereto. It is preferable that detection by the paper sensors 62A and 62B is performed before a toner image is transferred to paper P.

However, the paper sensors 62A and 62B may be provided at any position on the transporting path H on which paper P is transported.

In the first exemplary embodiment to the third exemplary embodiment, correction of parallelism which is performed, for example, by adjusting the angle of the fixing roll pair 32 with respect to the transfer roll 22 may be applied from paper P of which parallelism has been measured, or may be applied from paper P which is the next to the paper P of which parallelism has been measured.

In the first exemplary embodiment to the third exemplary embodiment, a case where a direct transfer type monochromic image forming apparatus is employed as the image forming apparatus is described.

However, it is not limited thereto. For example, a tandem type color image forming apparatus in which a toner image of each color is primarily transferred to the photoconductor body may be employed as the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first rotating body pair that transports a recording medium;
a second rotating body pair that transports the recording medium transported by the first rotating body pair;
a first detection unit that detects the recording medium at a first position in a transporting width direction of the recording medium, the transporting width direction being a direction that is perpendicular to a transporting direction of the recording medium;
a second detection unit that detects the recording medium at a second position, the second position being different from the first position in the transporting width direction; and
a modification unit that modifies a shape of an image to be formed on the recording medium in accordance with a difference between a detection time during which the recording medium is detected at the first position and a detection time during which the recording medium is detected at the second position.

2. The image forming apparatus according to claim 1, wherein
the first detection unit is provided between the first rotating body pair and the second rotating body pair, and
the second detection unit is provided between the first rotating body pair and the second rotating body pair.

3. The image forming apparatus according to claim 1, wherein
the second rotating body pair is provided so that a distance between the second rotating body pair and the first rotating body pair is shorter than a length of the recording medium in the transporting direction.

4. The image forming apparatus according to claim 1, wherein
the modification unit adjusts a relative angle between the first rotating body pair and the second rotating body pair in a transporting surface of the recording medium in accordance with the difference.

5. The image forming apparatus according to claim 4, wherein the modification unit adjusts an angle of the first rotating body pair with respect to the second rotating body pair in the transporting surface of the recording medium in accordance with the difference.

6. The image forming apparatus according to claim 1, further comprising:
a suggestion unit that suggests an adjustment amount of an angle of the first rotating body pair with respect to the second rotating body pair in a transporting surface of the recording medium in accordance with the difference.

7. The image forming apparatus according to claim 1, wherein
the modification unit calculates a modification coefficient for modifying the shape of the image to be formed on the recording medium in accordance with the difference, and modifies the shape of the image based on the calculated modification coefficient.

8. The image forming apparatus according to claim 4, wherein
the first rotating body pair comprises a photoconductor drum on which a toner image is formed and a transfer roll that transfers the toner image to the recording medium,
the second rotating body pair is a fixing roll pair that fixes the image, and
the modification unit adjusts an angle of the fixing roll pair in the transporting surface of the recording medium with respect to the transfer rolls in accordance with the difference.

9. The image forming apparatus according to claim 5, wherein
the first rotating body pair is a registration roll pair that performs skew correction on the recording medium which is transported,
the second rotating body pair comprises a photoconductor drum on which a toner image is formed and a transfer roll that transfers the toner image to the recording medium, and
the modification unit adjusts an angle of the registration roll pair in the transporting surface of the recording medium with respect to the transfer rolls in accordance with the difference.

10. The image forming apparatus according to claim 4, wherein
the first rotating body pair is a registration roll pair that performs skew correction on the recording medium which is transported,
the second rotating body pair is fixing rolls that fixes the image, and
the modification unit adjusts an angle of at least one of the registration roll pair and the fixing rolls in the transporting surface of the recording medium in accordance with the difference.

11. The image forming apparatus according to claim 1, wherein
the recording medium is transported upwardly in a vertical direction by the first rotating body pair and the second rotating body pair.

12. The image forming apparatus according to claim 1, wherein
in a case where the difference does not fall within a predetermined range, the modification unit modifies the shape of the image to be formed on the recording medium in accordance with the difference.

13. A non-transitory computer readable medium storing an image forming program causing a computer to function as the correction unit according to claim 1.
